(19) United States
(12) Patent Application Publication
(10) Pub. No.: US 2008/0072121 A1
(43) Pub. Date: Mar. 20, 2008

(54) Method and Apparatus For Repairing Defective Cell for Each Cell Section Word Line

(76) Inventors: Seung-min Lee, Suwon-si (KR); Chul-sung Park, Seoul (KR); Young-seung Kim, Seoul (KR); Byeong-uk Yoo, Yongin-si (KR)

Correspondence Address: F. CHAU & ASSOCIATES, LLC, 130 WOODBURY ROAD, WOODBURY, NY, 11797, US

(21) Appl. No.: 11/750,527

(22) Filed: May 18, 2007

(30) Foreign Application Priority Data
Jul. 11, 2006 (KR) 10-2006-0064856

(51) Int. Cl. G06F 11/16

(52) U.S. Cl. 714/768; 714/E11.056

(57) ABSTRACT

A method and apparatus for repairing defective cells for each section word line. The repairing apparatus includes an address comparison unit and a repairing unit. The address comparison unit compares a main address of a defective address, indicating the location of a defective cell, to a main address of an external address. The address comparison unit determines when a redundancy main word line corresponding to the main address of the external address is activated. The repairing unit activates a redundancy section word line corresponding to a section address of the external address from among a plurality of redundancy section word lines connected to the redundancy main word line in order to repair the defective cell. Accordingly, defective cells are repaired for each section word line while minimizing the area of the repairing apparatus. Randomly generated defective cells can be efficiently repaired.

### CROSS-REFERENCE TO RELATED PATENT APPLICATION

This application claims priority to Korean Patent Application No. 10-2006-0064856, filed on Jul. 11, 2006, in the Korean Intellectual Property Office, the disclosure of which is hereby incorporated by reference herein in its entirety.

### BACKGROUND OF THE INVENTION

1. Technical Field

The present invention relates to a semiconductor memory device, and more particularly, to an apparatus and method for repairing a defective cell for each cell section word line.

2. Discussion of the Related Art

A synchronous dynamic random access memory (SDRAM) includes a plurality of memory cells arranged in a matrix. The SDRAM cannot operate normally when any one of the plurality of memory cells is defective.

As the SDRAM becomes highly integrated and its operating speed is increased, the possibility of generating a defective cell increases and the manufacturing yield is reduced. The reduced yield increases the overall manufacturing cost of the SDRAM. Accordingly, it is important to effectively repair a defective cell in order to improve the yield as well as the integration and operating speed of the SDRAM.

A semiconductor memory device generally includes a redundancy cell. When the semiconductor memory device is requested to write or read a defective cell, the semiconductor memory device writes or reads data to or from the redundancy cell. Accordingly, the problem caused by the defective cell can be avoided.

FIG. 1 illustrates a part of a conventional repairing apparatus 10. Referring to FIG. 1, the conventional repairing apparatus 10 is included in a semiconductor memory device (not shown) and repairs a defective cell of the semiconductor memory device. The repairing apparatus 10 includes an address comparator 20 that compares an external address EXT_ADDR to a defective address. The defective address is the address of the defective cell. Information about the defective cell is provided by a mode register set (not shown). The external address EXT_ADDR is used to write data to a memory cell array (not shown) or read data from the memory cell array.

The address comparator 20 of the conventional repairing apparatus 10 compares a main address of the external address EXT_ADDR to a main address of the defective address. Both the external address EXT_ADDR and the defective address include main address bits indicating the address of a main word line and section address bits indicating the address of a section word line. The section address is composed of a predetermined number of least significant bits of each of the external address EXT_ADDR and the defective address.

The address comparator 20 of the conventional repairing apparatus 10 compares the external address EXT_ADDR, from which the least significant hits representing the section address have been excluded, to the defective address, from which the least significant bits have been excluded.

FIG. 2 is a circuit diagram of a register used to construct the address comparator 20 illustrated in FIG. 1. Referring to FIGS. 1 and 2, the address comparator 20 includes register groups RS0, RS1, through RS(n-1) (where n is a natural number larger than 2). The register groups RS0, RS1, through RS(n-1) respectively store corresponding defective addresses. Each of the register groups RS0, RS1, through RS(n-1) includes registers RA0, RA1, through RA# (where # is a natural number).

Each of the registers RA0, RA1, through RA# includes a fusing unit 11 and a comparison unit 12. The fusing unit 11 programs and stores a defective address based on information about the defective cell provided by the mode register set (not shown). The fusing unit 11 programs and stores a logic high value “H” or a logic low value “L” according to whether a fuse is cut.

The comparison unit. 12 outputs a logic high value “H” when the bits of the external address EXT_ADDR are identical to the bits of the defective address. When all the bits of the external address EXT_ADDR correspond to all the bits of the defective address (a comparison of the predetermined number of least significant bits is excluded, as described above), the comparison units 12 of all the registers RA0, RA1, through RA# included in the corresponding register group RSa (where a is an integer larger than 0) output a logic high value (“H”) ROUT.

When the output of all the registers RA0, RA1, through RA# included in the register group RSa have a logic high value “H,” a redundancy main word line RMWL(a) corresponding to the defective address stored in the register group RSa is activated. When there is a request for writing and/or reading a defective cell that is to be repaired, the conventional repairing apparatus 10 activates the redundancy main word line corresponding to the main word line on which the defective cell is disposed so as to replace the defective cell with a redundancy cell. Accordingly, the conventional repairing apparatus 10 performs repair for each main word line.

When repair is performed for each main word line, high repairing efficiency can be obtained when defective cells are closely grouped. However, the repairing efficiency decreases when defective cells are randomly generated throughout the memory cell array due to, for example, transistor mismatch. Accordingly, a semiconductor memory device capable of repairing defective cells by units smaller than the main word line is used in highly integrated semiconductor memory devices where the defective cells tend to be generated throughout the memory cell array.

FIG. 3 illustrates a part of a conventional apparatus 30 for repairing defective cells for each section word line. Referring to FIG. 3, the repairing apparatus 30 includes a main address register MRGx (where x is an integer larger than 0) and a section address register SRGb (where b is an integer larger than 0). The section address register SRGb compares the section address of the external address EXT_ADDR to the section address of a defective address. Thus, when there is a request for writing and/or reading a defective cell that is to be repaired, only a redundancy section word line RSWLb corresponding to the section word line of the section in which the defective cell is located can be activated.

Accordingly, the repairing apparatus 30 performs repair for each section word line. A semiconductor memory device including the repairing apparatus 30 can therefore repair a defective cell by units of section word line so as to improve efficiency of repairing a randomly generated defective cell.

However, the repairing apparatus 30 requires a much larger number of registers and buses, compared to the repairing apparatus 10 illustrated in FIG. 1, in order to perform repair for each section word line. This increases the layout area of the semiconductor memory device.

### SUMMARY OF THE INVENTION

Exemplary embodiments of the present invention provide an apparatus for repairing defective cells of a semiconductor memory device. Defective cells are repaired for each section word line in order to minimize the layout area of the semiconductor memory device while increasing efficiency of repairing randomly generated defective cells.

Exemplary embodiments of the present invention also provide a method of repairing defective cells of a semiconductor memory device for each section in order to minimize the layout area of the semiconductor memory device while increasing efficiency of repairing randomly generated defective cells.

According to an exemplary embodiment of the present invention, there is provided a repairing apparatus comprising an address comparison unit and a repairing unit.

The address comparison unit compares a main address of a defective address indicating the position of a defective cell to a main address of an external address. Activation of a redundancy main word line corresponding to the main address is determined. The repairing unit activates a redundancy section word line corresponding to a section address of the external address from among redundancy section word lines connected to the redundancy main word line. The defective cell is thereby repaired

At least two of the redundancy section word lines correspond to section word lines connected to different main word lines of a memory cell array, respectively. The main address is the address of a main word line of the memory cell array and the section address is the address of a section word line connected in the main word line.

The repairing unit replaces a section of the memory cell array where the defective cell is located with a corresponding section of a redundancy cell array. The repairing unit is a decoder that combines the redundancy word line with the section address of the external address to active the redundancy section word line.

The address comparison unit comprises a decoder, a fuse box and a comparator. The decoder decodes the section address of the external address to activate an enable signal corresponding to the section address. The fuse box outputs a main address of a defective address stored in a register group corresponding to the enable signal from among a plurality of register groups. The comparator activates the redundancy main word line when the main address of the defective address, output from the fuse box, is identical to the main address of the external address.

At least two of the register groups respectively store different main addresses as the main addresses of defective addresses. Each of the register groups comprises a plurality of registers storing the main address of the defective address bit by bit, and switches outputting bit values stored therein to the comparator in response to the enable signal. Each of the registers comprises a fuse that is or is not cut depending on the bit value.

The section address of the external address corresponds to n least significant bits of the external address (where n is a natural number) The fuse box includes 2ⁿ register groups.

The comparator is shared by the plurality of register groups of the fuse box. The address comparison unit includes a plurality of fuse boxes. The repairing unit repairs defective cells having the same section address but different main addresses. The repairs may be simultaneous or may occur at different times.

According to another exemplary embodiment of the present invention, there is provided a repairing apparatus comprising a fuse box, a comparison unit and a repairing unit.

The fuse box outputs a defective address stored in a register group corresponding to an enable signal from among a plurality of register groups. The comparison unit activates a redundancy word line corresponding to the defective address when the defective address output corresponds to an external address. The repairing unit repairs a defective cell in response to the activation of the redundancy word line.

The comparison unit is shared by the plurality of register groups. The comparison unit compares a main address of the defective address to a main address of the external address

According to another exemplary embodiment of the present invention, there is provided a method of repairing a defective cell of a semiconductor memory device. The method includes comparing a main address of a defective address indicating the defective cell to a main address of an external address. A redundancy main word line corresponding to the main address is activated when the main address of the defective address is identical to the main address of the external address. A redundancy section word line corresponding to a section address of the external address from among redundancy section word lines connected to the redundancy main word line is activated in order to repair the defective cell.

### BRIEF DESCRIPTION OF THE DRAWINGS

The above and other features arid aspects of the exemplary embodiments of the present invention are described below with reference to the attached drawings in which:

FIG. 1 illustrates a part of a conventional repairing apparatus;

FIG. 2 is a circuit diagram of a register included in an address comparator illustrated in FIG. 1;

FIG. 3 illustrates a part of a conventional apparatus for repairing a defective cell for each section word line;

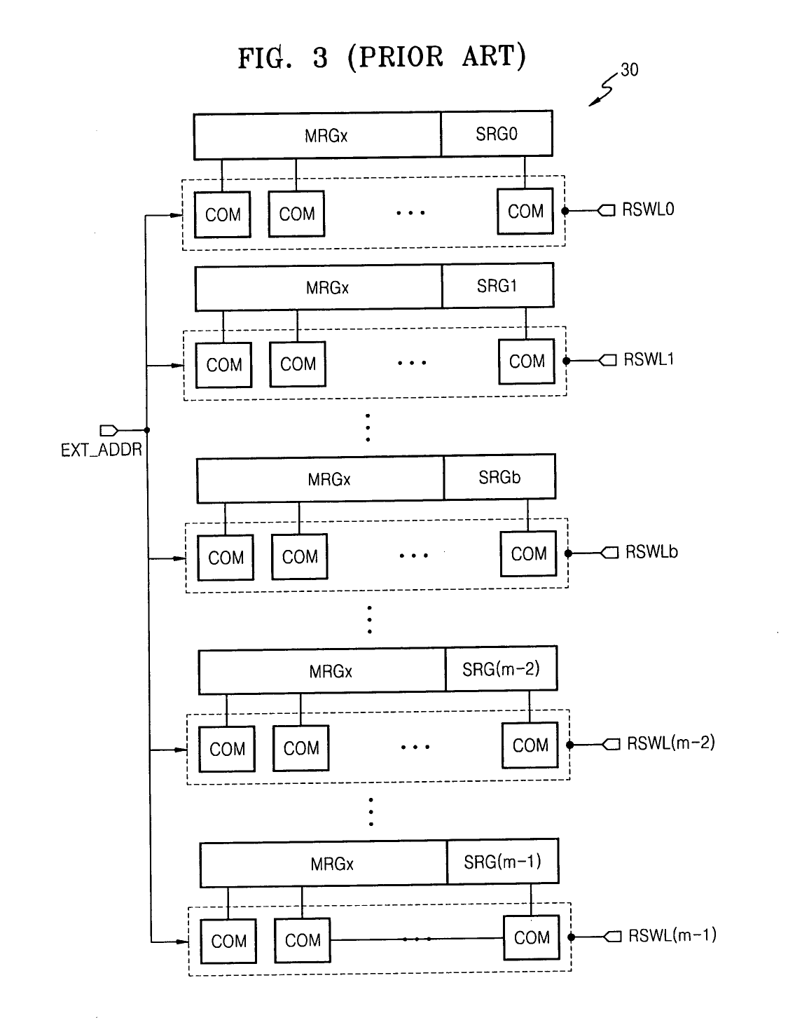

FIG. 4 is a block diagram of a repairing apparatus according to an exemplary embodiment of the present invention;

FIG. 5 illustrates the repairing apparatus of FIG. 4 in more detail;

FIG. 6 is a circuit diagram of a register group and a comparator illustrated in FIG. 5; and

FIG. 7 is a flow chart of a method of repairing a defective cell for each section word line according to an exemplary embodiment of the present invention.

### DESCRIPTION OF THE EXEMPLARY EMBODIMENTS

Exemplary embodiments of the present invention will now be described more fully with reference to the accompanying drawings. The invention may, however, be embodied in many different forms and should not be construed as being limited to the exemplary embodiments set forth herein. Throughout the drawings, like reference numerals may refer to like elements.

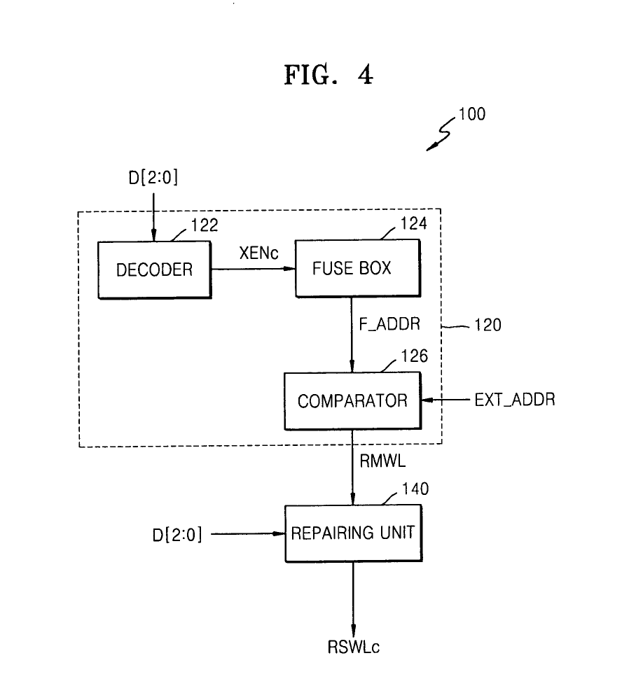

FIG. 4 is a block diagram of a repairing apparatus 100 according to an exemplary embodiment of the present invention. Referring to FIG. 4, the repairing apparatus 100 is capable of repairing defective cells for each section word line. The repairing apparatus 100 includes an address comparison unit 120 and a repairing unit 140. The address comparison unit 120 compares a main address of a defective address F_ADDR, indicating the position of a defective cell, to a main address of an external address EXT_ADDR. The main address is the address of a main word line of a memory cell array (not shown) of a semiconductor memory device. A section address, which is described below, is the address of a section word line included in the main word line. The defective address F_ADDR and the external address EXT_ADDR each have a data structure in which the main address is composed of upper bits and the section address is composed of lower bits.

The address comparison unit 120 determines activation of a redundancy main word line RMWL corresponding to the main address according to the comparison result. The address comparison unit 120 includes a decoder 122, a fuse box 124 and a comparator 126. The address comparison unit performs the aforementioned operation. The components of the address comparison unit 120 are discussed below.

The repairing unit 140 activates a redundancy section word line RSWLc (where c is an integer larger than 0) corresponding to a section address D[2:0] of the external address EXT_ADDR among redundancy section word lines. The redundancy section word line RSWLc is one of a plurality of section word lines connected to the main word line RMWL.

The repairing unit 140 repairs a defective cell by activating the redundancy section word line RSWLc. For example, the repairing unit 140 activates the redundancy section word line corresponding to the section of the memory cell array (not shown) where the defective cell is located to replace the section of the memory cell array with a corresponding section of a redundancy cell array.

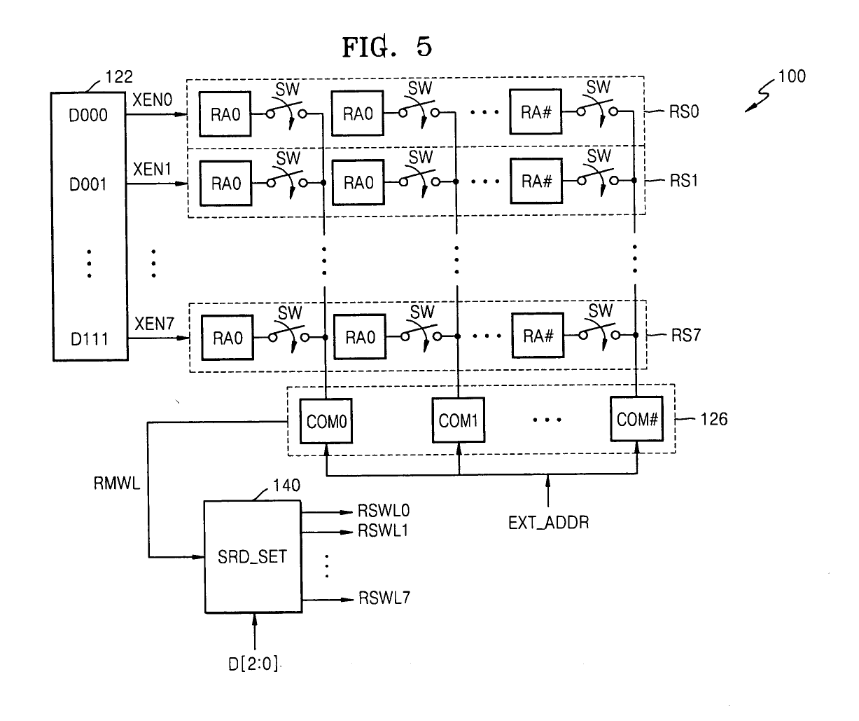

FIG. 5 illustrates the repairing apparatus of FIG. 4 in more detail. Referring to FIGS. 4 and 5, the fuse box 124 of the address comparison unit 120 includes register groups RS0 through RS7. The register groups RS0 through RS7 respectively store main addresses of corresponding defective addresses F_ADDR. Each of the register groups RS0 through RS7 includes registers RA0 through RA# (where # is a natural number) which store the main address of the defective address corresponding to each register group bit by bit. The registers RA0 through RA# store bit values using fuses, which are or are not cut depending on the bit value.

The register groups RS0 through RS7 output addresses stored therein in response to enable signals XEN0 through XEN7, respectively. The enable signals XEN0 through XEN7 are transmitted from the decoder 122. The decoder 122 decodes the section address D[2:0] of the external address EXT_ADDR and activates the enable signal XENc corresponding to the section address D[2:0].

As described above, the register groups RS0 through RS7 are activated according to the result of decoding of the section address D[2;0], and thus the number of register groups included in one fuse box 124 is determined by the number of bits representing the section address D[2:0] of the external address EXT_ADDR. In FIG. 5, the section address D[2;0] is composed of three least significant bits, and thus one fuse box 124 can include 8 (=2³ register groups RS0 through RS7.

The register groups RS0 through RS7 can respectively store different main addresses. For example, the register groups RS0 and RS1 can store different main addresses. The register groups RS0 through RS7 have different section addresses. The register groups RS0 through RS7 are activated by the enable signal XENc corresponding to the section address D[2:0].

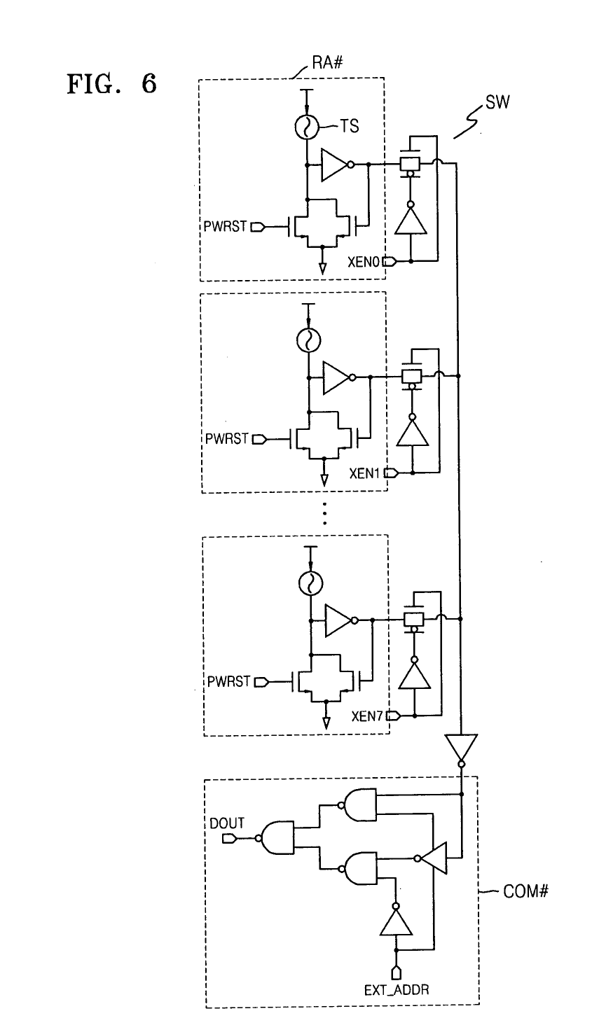

FIG. 6 is a circuit diagram of the register groups and comparator illustrated in FIG. 5. Referring to FIG. 6, switches of the register group are turned on when the enable signal corresponding to the register group is activated. FIG. 6 illustrates the #th register RA# and a switch SW of each register group. A comparator COM# is shared by a plurality of registers RA# and switches SW to reduce the layout area of the semiconductor memory device.

When the switch SW is turned on, a bit value stored in the register RA# is transferred to the comparator COM#. As described above, the register RA# stores the bit value in response to whether the fuse TS is cut or not. The comparator COM# compares the bit value transferred from the register RA# to the bit value of the external address EXT_ADDR. When the two bit values are identical to each other, the comparator COM# outputs a logic high value “H.”

Referring back to FIGS. 4 and 5, when the output of the comparator 126 has a logic high value “H,” the repairing apparatus 100 recognizes that the main address of the external address EXT_ADDR corresponds to the main address of the defective address F_ADDR. When the main address of the external address EXT_ADDR corresponds to the main address of the defective address F_ADDR, the comparator 126 activates the redundancy main word line RMWL.

The repairing unit 140 combines the redundancy main word line RMWL with the section address D[2:0] of the external address EXT_ADDR and activates one of the redundancy section word lines RSWL0 through RSWL7. The redundancy section word lines RSWL0 through RSWL7 respectively correspond to section word lines respectively having different main word lines as upper word lines.

For example, the redundancy section word lines RSWL0 through RSWL7 corresponding to section addresses having different main address as upper addresses are connected to one redundancy main word line RMWL. The repairing apparatus 100 stores a plurality of main addresses having different section addresses in one fuse box 124 and the redundancy main word line RMWL corresponds to different main addresses.

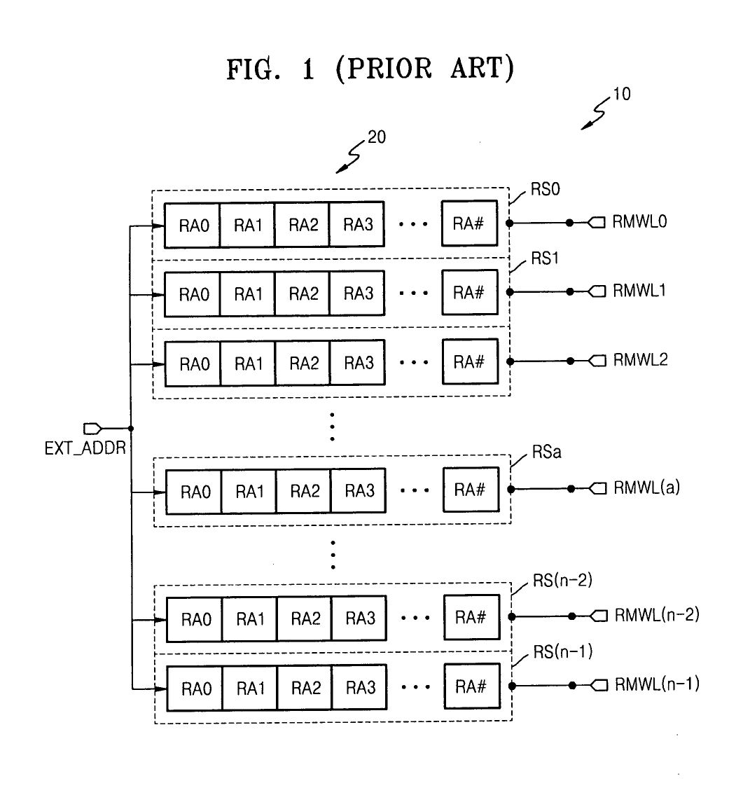

Accordingly, the repairing apparatus 100 performs repair according to the activation of one of eight redundancy section word lines RSWL0 through RSWL7 corresponding to the different main addresses. This is distinguished from the repairing apparatus 10 illustrated in FIG. 1, which carries out repairing according to the activation of the redundancy main word line RMWL corresponding to the same main address. For example, the repairing apparatus 100 according to an exemplary embodiment of the present invention can perform repair for each section word line. This is distinguished from the repairing apparatus 10 carrying out repair for each main word line, as illustrated in FIG. 1.

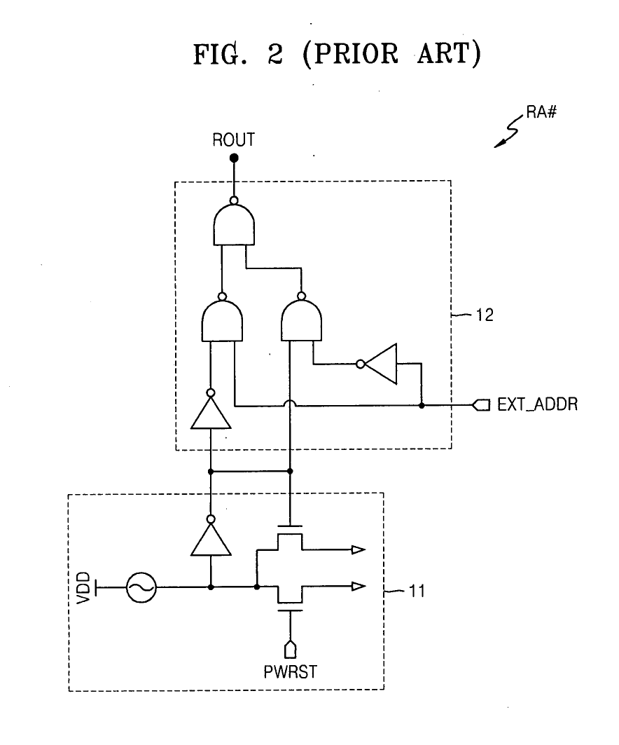

Furthermore, the register groups RS0 through RS7 of the repairing apparatus 100 share one comparator 126 while the register groups RS0 through RS(n-1) (where n is a natural number larger than 2) of the repairing apparatus 10 illustrated in FIG. 1 each respectively include a comparator (11 of FIG. 2). Moreover, the repairing apparatus 100 of an exemplary embodiment of the present invention does not require the number of buses to be increased. The repairing apparatus 30 illustrated in FIG 2 requires a much larger number of buses.

Consequently, the repairing apparatus 100 according to an exemplary embodiment of the present invention can reduce the area by 30% or more, compared to the repairing apparatus 30 illustrated in FIG. 2, while performing repairing by the unit of section word line.

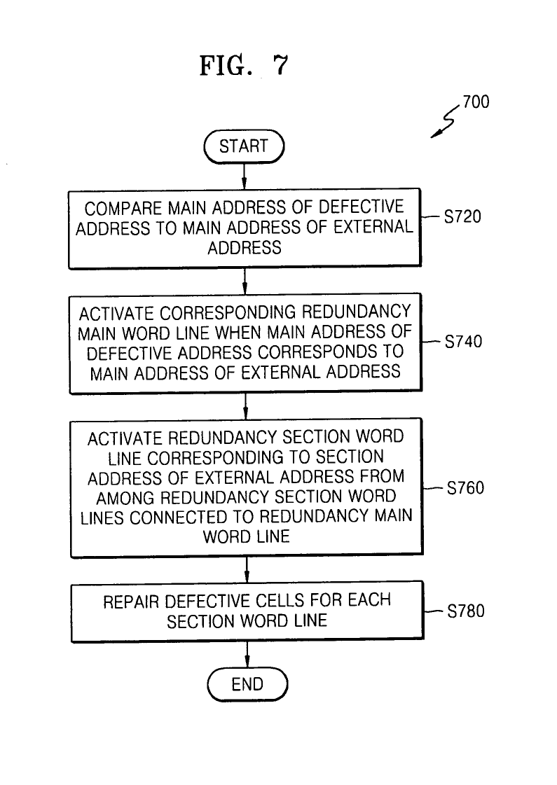

FIG. 7 is a flow chart of a method 700 of repairing defective cells for each section word line according to an exemplary embodiment of the present invention. Referring to FIG. 7, the method 700 includes comparing a main address of a defective address indicating the position of a defective cell to a main address of an external address (Step S720). A redundancy main word line corresponding to the main address is activated when the main address of the defective address is identical to the main address of the external address (Step S740). A redundancy section word line corresponding to a section address of the external address from among redundancy section word lines connected to the redundancy main word line is activated (Step S760). The defective cell is repaired (Step S780).

While exemplary embodiments of the present invention have been particularly shown and described with reference to the figures, it will be understood by those of ordinary skill in the art that various changes in form and details may be made therein without departing from the spirit and scope of the present invention. For example, while the address comparison unit 120 illustrated in FIG. 5 includes one fuse box 124, the address comparison unit 120 can include M fuse boxes (where M is a natural number larger than 2). When the address comparison unit 120 includes the M fuse boxes, M repairing addresses can be set for the same section address D[2:0]. Here, the repairing unit 140 can repair defective cells having the same section address but different main addresses simultaneously or separately.

Furthermore, while the redundancy section word lines RSWL0 through RSWL7 respectively correspond to different main addresses in FIG. 5, the redundancy section word lines RSWL0 through RSWL7 can correspond to the same main address.

What is claimed is:

1. A repairing apparatus comprising:
an address comparison unit comparing a main address of a defective address, indicating location of a defective cell, to a main address of an external address and determining whether to activate a redundancy main word line corresponding to the main address of the external address depending upon a result of the comparison; and
a repairing unit activating a redundancy section word line corresponding to a section address of the external address from among a plurality of redundancy section word lines connected to the redundancy main word line and repairing the defective cell,
wherein at least two of the redundancy section word lines of the plurality of redundancy section word lines correspond to section word lines connected to different main word lines of a memory cell array.

2. The repairing apparatus of claim 1, wherein the main address of the defective address is an address of a main word line of the memory cell array and the section address of the defective address is an address of a section word line connected in the main word line.

3. The repairing apparatus of claim 1, wherein the repairing unit replaces a section of the memory cell array where the defective cell is located with a corresponding section of a redundancy cell array.

4. The repairing apparatus of claim 1, wherein the repairing unit is a decoder that combines the redundancy main word line with the section address of the external address to active the redundancy section word line.

5. The repairing apparatus of claim 1, wherein the address comparison unit comprises:
a decoder decoding the section address of the external address and activating an enable signal corresponding to the section address of the external address;
a fuse box outputting the main address of the defective address stored in a register group, from among a plurality of register groups, corresponding to the enable signal; and
a comparator activating the redundancy main word line when the main address of the defective address, output from the fuse box, is identical to the main address of the external address.

6. The repairing apparatus of claim 5, wherein at least two of the register groups respectively store different main addresses as the main addresses of defective addresses.

7. The repairing apparatus of claim 5, wherein each of the register groups comprises:
a plurality of registers storing the main address of the defective address bit by bit; and
a plurality of switches outputting bit values stored therein to the comparator in response to the enable signal.

8. The repairing apparatus of claim 7, wherein each of the registers comprises a fuse that is cut depending upon the bit value.

9. The repairing apparatus of claim 5, wherein the section address of the external address comprises a plurality of least significant bits of the external address.

10. The repairing apparatus of claim 9, wherein the fuse box includes 2ⁿ register groups, wherein n is the number of least significant bits in the section address of the external address.

11. The repairing apparatus of claim 5, wherein the comparator is shared by the plurality of register groups of the fuse box.

12. The repairing apparatus of claim 5, wherein the address comparison unit includes a plurality of fuse boxes.

13. The repairing apparatus of claim 12, wherein the repairing unit repairs defective cells having the same section address but different main addresses.

14. A repairing apparatus comprising:
a fuse box outputting a defective address stored in a register group, from among a plurality of register groups, corresponding to an enable signal;
a comparison unit activating a redundancy word line corresponding to the defective address when the defective address output by the fuse box corresponds to an external address; and
a repairing unit repairing a defective cell in response to the activation of the redundancy word line,
wherein the comparison unit is shared by the plurality of register groups.

15. The repairing apparatus of claim 14, wherein the comparison unit compares a main address of the defective address to a main address of the external address.

16. The repairing apparatus of claim 15, wherein at least two of the plurality of register groups respectively store different main addresses as the main addresses of defective addresses.

17. The repairing apparatus of claim 14, wherein the repairing unit includes a decoder that combines the redundancy word line with a section address of the external address to activate a corresponding redundancy section word line of a plurality of redundancy section word lines.

18. The repairing apparatus of claim 17, wherein at least two of the plurality of redundancy section word lines correspond to section word lines connected to different main word lines of a memory cell array.

19. The repairing apparatus of claim 18, wherein the repairing unit replaces a section of the memory cell array where the defective cell is located with a corresponding section of a redundancy cell array.

20. The repairing apparatus of claim 14, further comprising a decoder decoding a section address of the external address in order to activate an enable signal corresponding to the section address.

21. A method of repairing a defective cell of a semiconductor memory device, comprising:
comparing a main address of a defective address indicating a location of the defective cell to a main address of an external address;
activating a redundancy main word line corresponding to the main address of the external address when the main address of the defective address is identical to the main address of the external address; and
activating a redundancy section word line, corresponding to a section address of the external address, from among a plurality of redundancy section word lines connected to the redundancy main word line and repairing the defective cell,
wherein at least two of the redundancy section word lines of the plurality of redundancy section word lines correspond to section word lines connected to different main word lines of a memory cell array.

22. The method of claim 21, wherein the repairing of the defective cell comprises replacing a section of the memory cell array where the defective cell is located with a corresponding section of a redundancy cell array.

23. The method of claim 21, further comprising:
decoding the section address of the external address and activating an enable signal corresponding to the section address of the external address; and
outputting the main address of the defective address stored in a register group, from among a plurality of register groups, corresponding to the enable signal.

24. The method of claim 23, wherein at least two of the plurality of register groups respectively store different main addresses as the main addresses of defective addresses.
